(19) United States
(12) Patent Application Publication
(10) Pub. No.: US 2014/0327506 A1
(43) Pub. Date: Nov. 6, 2014

(54) OIL TRANSFORMER

(71) Applicant: ABB TECHNOLOGY AG, Zurich (CH)

(72) Inventors: Andreas GUSTAFSSON, Ludvika (SE); Erik Wedin, Ludvika (SE); Johan Engström, Borlange (SE); Erik Forsberg, Smedjebacken (SE); Lars E. Schmidt, Oskarshamn (SE); Hartmut Brendel, Halle (DE)

(73) Assignee: ABB TECHNOLOGY AG, Zurich (CH)

(21) Appl. No.: 14/299,265

(22) Filed: Jun. 9, 2014

Related U.S. Application Data
(63) Continuation of application No. PCT/EP2012/004882, filed on Nov. 27, 2012.

(30) Foreign Application Priority Data
Dec. 8, 2011 (EP) 11009670.8

(51) Int. Cl. H01F 27/12

(52) U.S. Cl. CPC H01F 27/12
USPC 336/58

(57) ABSTRACT

An oil transformer includes a transformer vessel, a transformer core mounted in the vessel, at least one upright hollow cylindrical transformer coil including at least one axial cooling channel arranged around a limb of the transformer core, and an oil chamber arranged at an axial front side of the transformer coil. At least one first opening leading from the inner chamber to the belonging front side of the transformer coil is provided, and at least one second opening is provided within the surrounding boundaries of the oil chamber. The oil chamber is an under-pressure chamber, wherein the at least one first opening is an inlet port and the at least one second opening is an outlet port.

### RELATED APPLICATIONS

This application claims priority as a continuation application under 35 U.S.C. §120 to PCT/EP2012/004882, which was filed as an International Application on Nov. 27, 2012 designating the U.S., and which claims priority to European Application 11009670.8 filed in Europe on Dec. 8, 2011. The entire contents of these applications are hereby incorporated by reference in their entireties.

### FIELD

The present disclosure relates to an oil transformer.

### BACKGROUND INFORMATION

It is known that transformers in energy distribution networks with a rated voltage of 110 kV or 380 kV, for example, may be designed as oil transformers. The transformer core with its coils is arranged in an oil filled vessel, wherein the oil is on one side an insulation medium and on the other side a cooling medium. The oil circulates in between cooling channels through the coil windings, where heat losses are generated during operation of the transformer, and a cooling device which transfers the heat from the oil to the outer environment. The circulation of the oil might be generated by a pump, for example, but natural convection is also possible.

The transformer coil has to become mechanically strengthened to withstand the mechanical forces which occur in between neighbored conductor windings during a short-circuit, which might cause a temporary current of, for example, 100 kA or higher. Especially in the axial direction of the transformer winding, such a mechanical strengthening is required, wherein in the radial direction the ring like arrangement of the windings around the winding axis is strong enough to withstand the belonging short-circuit forces. Compared with the forces caused by the weight of the transformer coil itself, the axial forces during short-circuit might, for example, be five times higher.

Thus, an axial clamping structure is required at both axial ends of the transformer coil, which puts an axial clamping pressure on the axial ends of the coil, and which prevents a mechanical deformation of the coil in axial direction during a short circuit. This clamping structure has to be designed in a way that an oil flow through this structure to the inner cooling channels of the transformer coil clamped therein is enabled, respectively from the inner cooling channels through the clamping structure at the opposite side of the transformer winding.

An oil chamber may be provided for an improved oil flow through the cooling channels of the belonging transformer coils. Such an oil chamber is normally disc-like shaped and placed under a belonging upright coil and is fluidly connected with its axial cooling channels. Cooled oil is pressurized within this oil chamber, so that the oil flows up through the cooling channels to the upper axial end of the coil. The belonging lower coil fixture may be integrated as part of a belonging oil chamber. Thus, an oil chamber includes a press ring building the bottom plate of the oil chamber as well as a spacer ring, wherein additional low bordering walls are provided at the radial edges of the spacer ring to enable the inner chamber to withstand the pressure of the oil. Furthermore, flat perforated panels on top of the spacer ring are provided, which are building the top cover of the oil chamber. The purpose of the perforation is the passage of the oil from the inner oil chamber to the transformer winding. An example of an oil chamber is disclosed in U.S. Pat. No. 4,424,502, the entire disclosure of which is hereby incorporated by reference.

Within the context of the present disclosure, a transformer is to be understood as a synonym for a series reactor or shunt, for example, which are arranged within an oil vessel in a comparable way than a transformer as such. Both components have a similar structure as a transformer core with coil and axial cooling channels and thus both components require a comparable cooling system. In a comparable way, a transformer core is to be understood within the context of the present disclosure as a synonym for a wide range of types as transformer cores including a reactor core limb, for example. Also, the wording “ring-shaped” is used herein broadly and also covers a square-shaped ring, for example.

A disadvantage with known configurations is that such an arrangement is on the one hand difficult to manufacture since the transformer winding—which might have a weight of several tons—may be assembled directly on top of the oil chamber. On the other hand, the effectiveness of the cooling system is not as high, since oil is sucked from the top of the vessel, where the heated oil from the transformer coil has already been mixed with other oil.

### SUMMARY

An exemplary embodiment of the present disclosure provides an oil transformer which includes a transformer vessel, and a transformer core mounted in the transformer vessel, where the transformer core including at least one limb. In addition, the exemplary oil transformer includes at least one upright hollow cylindrical transformer coil including at least one axial cooling channel arranged around the limb of the transformer core. The exemplary oil transformer also includes an oil chamber arranged within the transformer vessel on an upper side of the upright transformer coil. The oil chamber forms a coil fixture for the transformer coil by applying pressure on the transformer coil. At least one first opening leading from inside the oil chamber to the upper side of the transformer coil is provided, and at least one second opening is provided within surrounding boundaries of the oil chamber. The at least one first opening is an inlet port for oil and the at least one second opening is an outlet port for oil.

### BRIEF DESCRIPTION OF THE DRAWINGS

Additional refinements, advantages and features of the present disclosure are described in more detail below with reference to exemplary embodiments illustrated in the drawings, in which:

FIG. 1 shows an oil transformer according to an exemplary embodiment of the present disclosure;

FIG. 2 shows an oil chamber according to an exemplary embodiment of the present disclosure;

FIG. 3 shows an oil chamber according to an exemplary embodiment of the present disclosure;

FIG. 4 shows an oil chamber according to an exemplary embodiment of the present disclosure; and

FIG. 5 shows an example of flexural strength of a laminated bar according to an exemplary embodiment of the present disclosure.

### DETAILED DESCRIPTION

Exemplary embodiments of the present disclosure provide an oil transformer which has an improved cooling system and which is easier to assemble.

An exemplary embodiment of the present disclosure provides an oil transformer which includes a transformer vessel, and a transformer core mounted in the transformer vessel, where the transformer core including at least one limb. In addition, the exemplary oil transformer includes at least one upright hollow cylindrical transformer coil including at least one axial cooling channel arranged around the limb of the transformer core. The exemplary oil transformer also includes an oil chamber arranged within the transformer vessel on an upper side of the upright transformer coil. The oil chamber forms a coil fixture for the transformer coil by applying pressure on the transformer coil. At least one first opening leading from inside the oil chamber to the upper side of the transformer coil is provided, and at least one second opening is provided within surrounding boundaries of the oil chamber. The at least one first opening is an inlet port for oil and the at least one second opening is an outlet port for oil. In accordance with an exemplary embodiment, the oil chamber is an under-pressure chamber, wherein the at least one first opening is an inlet port and the at least one second opening is an outlet port. According to an exemplary embodiment of the present disclosure, the oil chamber is arranged on the upper side of the upright transformer coil.

An oil chamber as such has to be understood as inner space surrounded by boundaries respectively walls, so that an under-pressure can be generated therein. The walls have not to be necessarily part of the oil chamber. Moreover, they can also be built by walls or sides of adjacent parts. The transformer vessel may be filled with an insulation (e.g., dielectric insulation fluid) to ensure a proper functionality, for example, with transformer oil. Of course, other suitable insulation fluids such as bio temp fluids are also possible.

Thus the oil flow through the axial cooling channels of the transformer coil is—in case of an arrangement of the oil chamber on the upper side of the upper transformer coil—directed upwards so that—even if no pump or comparable device is provided for the revolution of the oil—a natural cooling circuit is realized at least as fall back solution. In an advantageous manner the oil is sucked of the upper axial end of the transformer coil and preferably directly fed into a cooling system by using a pump or comparable device. It is also within the scope of the present disclosure that the oil chamber is arranged like a ring, which is surrounding radial outer side of the transformer coil, whereas the belonging flat axial end of the transformer coil as such is not or not completely in contact with the oil chamber.

Most of the heat losses are generated within the windings of the transformer coils. During operation of the transformer circulating oil is heated within the cooling channels of the transformer coil and fed directly afterwards to a cooling system outside the transformer. Since this oil is not mixed with other oil within the transformer vessel, which might be not as heated, the temperature of oil flowing into the cooling system is rather high. As higher the temperature difference between oil to be cooled and the environment, where the heat has to be transferred, as better is the effectiveness of the cooling system. Thus the cooling effect is increased in an advantageous way.

According to an exemplary embodiment of the present disclosure, rib-like spacer elements are provided within the oil chamber, which are suitable for supporting a pressure force on the transformer coil. In the case of a short circuit, the electrical current through the winding might increase temporary to a value of 100 kA and higher. Thus, belonging forces in between adjacent windings are applied. In the radial direction, the winding withstands those forces due to its circular arrangement around a (virtual) center axis. In the axial direction, the structure of the transformer winding as such is not provided to withstand such forces, which might correspond to five times or more of the weight of the transformer coil itself. Thus, a coil fixture is provided at each axial end of the at least transformer coil to put a belonging pressure force thereon. For this reason, the spacer elements, which might distributed radially or axially, for example, are provided for applying such pressure force on the upper axial end of the coil. To ensure an unhindered oil flow between oil chamber and the upper axial front side of the transformer coil, they are fluidly connected.

According to an exemplary embodiment of the present disclosure, the at least one axial cooling channel of the transformer coil and the at least one first opening are arranged at least approximately congruent concerning their cross sections. In accordance with an exemplary embodiment, the oil chamber is walled on one axial side by a press ring and on the opposite side by flat perforated panels, which include the at least one fist opening as aconnection to the belonging front side of the transformer coil respectively its cooling channels. An approximately congruent adaptation of the belonging cross sections respectively arrangements improves once more the unhindered oil flow in between oil chamber and cooling channels.

According to an exemplary embodiment of the present disclosure, the at least one second opening is prolonged from the oil chamber in a tube-like manner. Thus, an outlet duct from the inner oil chamber through the vessel is realized, which may end directly at a cooling system outside the transformer, where the oil is cooled down and fed back into the transformer vessel. In case of several, for example, three, transformer coils arranged within the transformer vessel, several ducts might be realized as common collecting duct. It is furthermore possible to collect the outlet oil from the under pressure oil chamber to a larger pipe before leading it to the cooling equipment.

According to an exemplary embodiment of the present disclosure, the at least one second opening leads from the oil chamber directly to a cooling system outside the transformer vessel, wherein a belonging connection might be realized as collecting duct. Thus, the heated oil is fed to the external cooling system with its maximum temperature. An external cooling system might be for example a heat exchanger with an optional air blower for example and cooling ribs.

According to an exemplary embodiment of the present disclosure, the oil chamber includes a ring-shaped ground plate, rib-like spacer elements arranged thereon and low bordering walls at the radial outer and inner edge of the ground plate, wherein the ground plate is manufactured together with at least one of the other elements as a monolithic part.

As explained above, an oil chamber might be subject to a pressure force especially in the case of a short circuit. Thus, a certain flexural strength of the oil chamber is required to withstand. The flexural strength of a part is on one side dependent on the height of the part and on the other side on the characteristics of the material. If, for example, two identical bars are placed on each other, the total flexural strength is twice as high as for one single bar. If on the other side a monolithic bar of the same material and same size is considered, the flexural strength is four times higher than for a single bar and twice as high as for the two single bars due to a quadratic dependency between thickness and flexural strength of monolithic parts.

Since the spacer elements according to the present disclosure are rib-like shaped—similar to a bar—they are also suitable for a contribution to an increased flexural strength of the oil chamber. Thus, an arrangement of, for example, a 9 cm press ring and a 5 cm spacer ring can be replaced by an at least partly monolithic oil chamber of, for example, 11 cm height with comparable and sufficient flexural strength. According to an exemplary embodiment, the method of milling is used for the manufacturing of such at least partly monolithic oil chamber. This is usually supported by CAD systems, so that a nearly unlimited variation of shapes can be realized therewith.

According to an exemplary embodiment of the present disclosure, the rib-like spacer elements are shaped at their side-walls in a way which differs from a plane perpendicular to the ground plate, so that the axial creeping distance along the side walls is prolonged. Those spacer elements also have to fulfil requirements of insulation—each front side of a transformer coil is on high voltage level during the operation of the transformer, whereas the adjacent transformer core is on earth (ground) potential. Since the overall thickness of the oil chamber is reduced in an advantageous way by the present disclosure, it is also within the scope of the present disclosure to gain at least the same axial insulation ability which is provided by a comparable known oil chamber.

According to an exemplary embodiment of the present disclosure, the monolithic part consists of (e.g., includes) laminated material. A laminated material consists of several flat layers which are glued together by using a high pressure. Thus, a monolithic block of extreme high stiffness is produced, which is also suitable to be milled in a desired shape. According to an exemplary embodiment of the present disclosure, the monolithic block respectively part consists at least predominantly of press-board. This is a cellulose based material of a high stiffness and excellent electrical insulation capability, which is very suitable for the use in oil transformers, for example, as supporting element.

Additional exemplary embodiments of the present disclosure are described in more detail below with reference to the drawings.

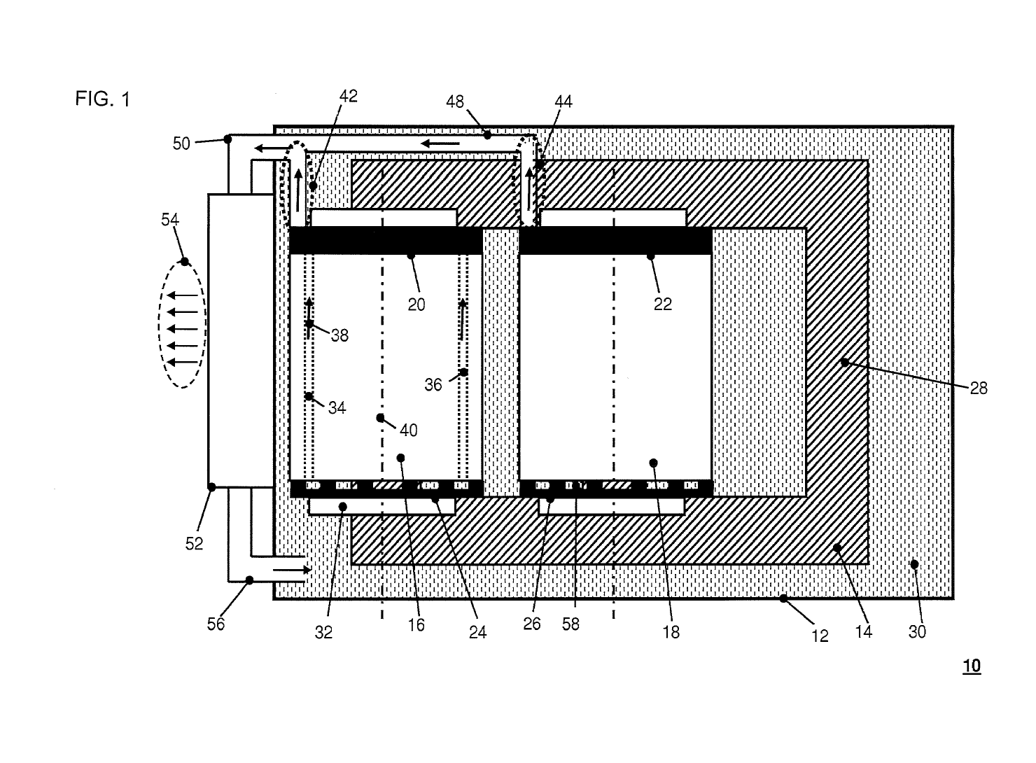

FIG. 1 shows an exemplary embodiment of an oil transformer 10 in a sectional drawing. A transformer core 14 with three limbs 28 and two exemplary upright transformer coils 16, 18 mounted thereon is arranged within a transformer vessel 12. The transformer vessel 12 is filled with transformer oil 30, which is on one hand provided for purposes of electrical insulation, such as for cooling, for example.

The transformer coils 16, 18 are hollow cylindrical components arranged along a belonging virtual center axis 40 and clamped in between a lower coil fixture 24, 26 and an upper oil chamber 20, 22, which are constructed in that way, that they can apply a pressure force on the coil, comparable to the lower coil fixtures 24, 26. The lower coil fixtures 24, 26 correspond in principal more or less to the oil chambers 20, 22, so they include a ground plate with an inner opening for a transformer limb 28 and spacer elements arranged thereon, whereas flow channels 58 are formed in between adjacent spacer elements. Axial cooling channels 34, 36 are provided through the transformer coils 16, 18, so that transformer oil 30 can flow therethrough as indicated with the arrow 38. Thus, the transformer oil is heated while flowing through the cooling channels 34, 36 of the transformer and fed into the oil chambers 20, 22 afterwards. The second openings of the oil chambers are prolonged tubes 42, 44, which are connected with a collecting duct 48 for feeding the oil through a suction tube 50 to a cooling system 52. According to an exemplary embodiment, the cooling system 52 may be realized as a heat exchanger with a blower, which transfers the heat energy to the environment as indicated with the arrows 54. Furthermore, a pump may be provided to generate an under-pressure within the oil chambers 20, 22. It is to be understood that other means for generating under-pressure such as radiators, for example, are a possible solution. Thus, the under-pressure might also be generated by pure buoyancy forces. After cooling down, the oil within the cooling system 52 it is fed back into the inner transformer vessel 12 by an output tube 56.

The output tube 56 has to be assumed as being prolonged to belonging areas under thermo-critical components such as transformer windings 16, 18 for example. Thus, the cooled oil fed back from the cooling system 52 is provided in those areas, which might require enforced cooling, if no radiators are used, for example.

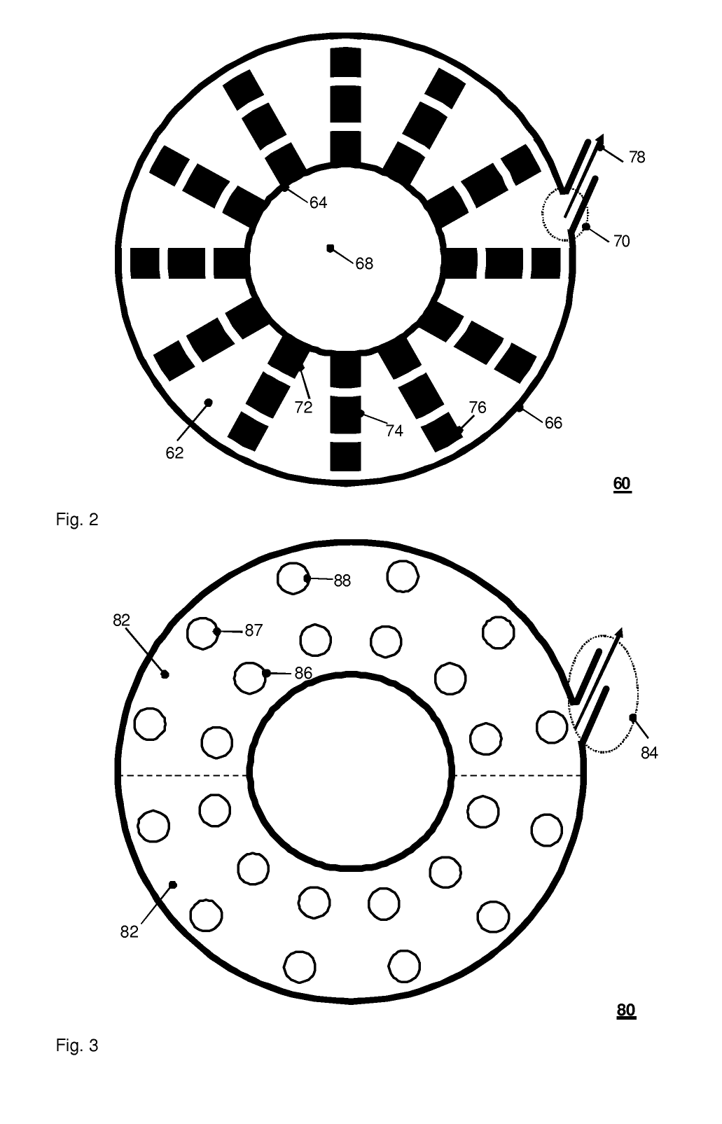

FIG. 2 shows an exemplary embodiment of an oil chamber 60 in a top view drawing. On a ring-shaped ground plate 62 with inner opening 68, several rib-like spacer elements 72, 74, 76 are arranged in the radial direction. The radial inner and radial outer edges of the ground plate 62 are surrounded by low bordering walls 64, 68, so that an inner chamber is formed. A second opening 72 is provided at the radial outer bordering wall as an outlet for oil as indicated with the arrow 78. According to an exemplary embodiment, the second opening might also be arranged through the top or bottom walls of the oil chamber, dependent on the available space within the transformer. The opening is prolonged by a tube through which the oil sucked out of the oil chamber therethrough can easily be fed to an external cooling system. Ground plate 62 and bordering walls 64, 66 are made from one monolithic part, so that the flexural stability of the oil chamber is increased in an advantageous way. An exemplary thickness of the ground plate in such a monolithic arrangement might amount to 8 to 12 cm, whereas the height of the spacer elements at the bordering walls might amount to 6 to 8 cm, for example.

FIG. 3 shows an exemplary embodiment of an oil chamber 80 in a top view drawing. This chamber corresponds in principal to the chamber shown in FIG. 2, whereas additional flat perforated panels 82 on top of the spacer ring are provided, which are building the top cover of the oil chamber in this drawing. When mounted on the upper axial end of a transformer coil, those perforated panels will be at the bottom of the oil chamber. The positioning and cross section of the perforation holes, respectively, first openings 86, 87, 88 are adapted to the cross section and positioning of axial cooling channels of a transformer winding to be arranged below. The prolonged second opening respectively the outlet duct is marked with reference number 84. Those flat panels are not part of a monolithic structure, since due do reasons of manufacturing a full accessibility of the inner oil chamber has to be observed.

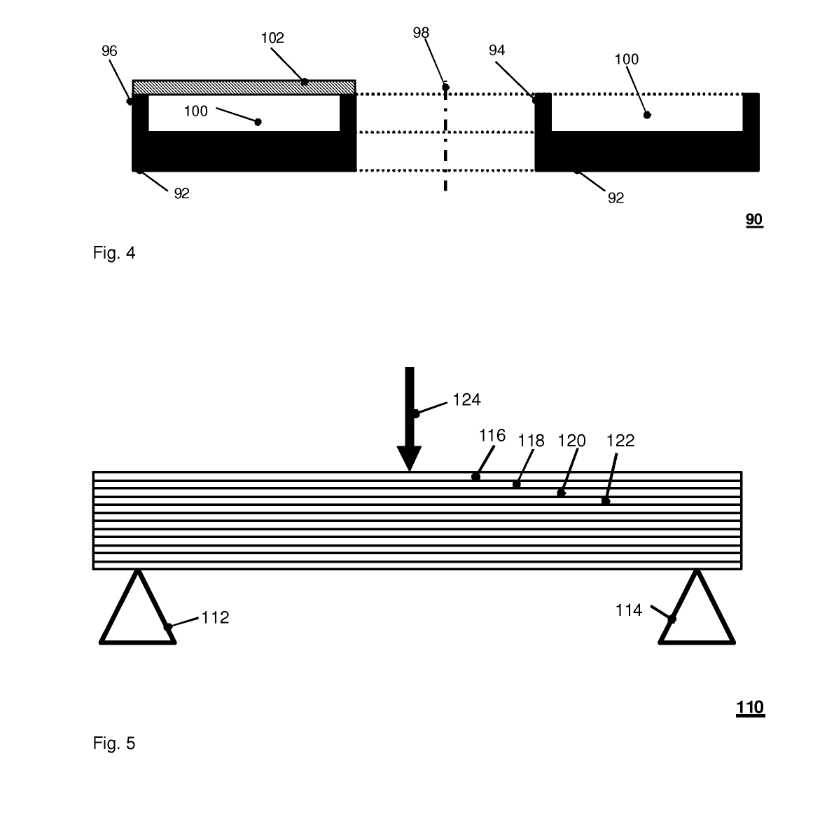

FIG. 4 shows an exemplary embodiment of an oil chamber 90 as a cross section from a side view. Around a virtual center axis 98, a disc-like ground plate 92 with radial inner 94 and radial outer 96 bordering wall is provided. The inner area 100 of the oil chamber is formed by the bordering walls 92, 94, the ground plate 92 and flat panels 102 on top of this chamber. Spacer elements within the inner area of the oil chamber are not shown but are present.

FIG. 5 shows an example of flexural strength of a laminated bar in a sketch 110. Several layers 116, 118, 120, 122 of press board are laminated to a bar. In between the laminated layers, glue or epoxy resin, for example, has been added during the lamination process. At its outer sides, the bar is seated on two triangular supports 112, 114. A pressure force 124 is applied in the middle of the bar. The bowing of the bar is lower per pressure force due to the higher flexural strength. Due to the high-strength adhesion in between the different layers, the flexural strength of the laminated bar is at least as high as the flexural strength of a massive, non-laminated bar of the same size.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 exemplary oil transformer

12 transformer vessel

14 transformer core

16 first upright hollow cylindrical transformer coil

18 second upright hollow cylindrical transformer coil

20 first oil chamber

22 second oil chamber

24 first coil fixture

26 second coil fixture

28 transformer limb

30 transformer oil

32 press support

34 first axial cooling channel

36 second axial cooling channel

38 flow direction through cooling channel

40 virtual center axis

42 prolongation of second opening of first transformer coil

44 prolongation of second opening of second transformer coil

48 first suction tube

50 second suction tube

52 cooling system

54 heated air

56 output tube

60 exemplary oil chamber

62 ring-shaped ground plate

64 radial inner bordering wall

66 radial outer bordering wall

68 inner opening

70 second opening

72 radial inner rib-like spacer element

74 radial middle rib-like spacer element

76 radial outer rib-like spacer element

78 flow direction out of oil chamber

80 exemplary fourth oil chamber

82 flat panels

84 prolongation of second opening of fourth oil chamber

86 first first opening of fourth oil chamber

87 second first opening of fourth oil chamber

88 third first opening of fourth oil chamber

90 exemplary oil chamber

92 ring-shaped ground plate

94 radial inner bordering wall

96 radial outer bordering wall

98 virtual center axis

100 inner area of fifth oil chamber

102 flat panel

110 example of flexural strength of a laminated bar

112 first support

114 second support

116 first layer of laminated bar

118 second layer of laminated bar

120 third layer of laminated bar

122 forth layer of laminated bar

124 force

What is claimed is:

1. An oil transformer, comprising:
a transformer vessel;
a transformer core mounted in the transformer vessel, the transformer core including at least one limb;
at least one upright hollow cylindrical transformer coil including at least one axial cooling channel arranged around the limb of the transformer core;
an oil chamber arranged within the transformer vessel on an upper side of the upright transformer coil, the oil chamber forming a coil fixture for the transformer coil by applying pressure on the transformer coil;
at least one first opening leading from inside the oil chamber to the upper side of the transformer coil; and
at least one second opening within surrounding boundaries of the oil chamber,
wherein the at least one first opening is an inlet port for oil and the at least one second opening is an outlet port for oil.

2. The oil transformer according claim 1, wherein the oil chamber is fluidly connected with an upper axial front side of the transformer coil.

3. The oil transformer according to claim 1, wherein the at least one axial cooling channel of the transformer coil and the at least one first opening are arranged congruent to each other with respect to their respective cross sections.

4. The oil transformer according to claim 1, wherein the at least one second opening is prolonged from the oil chamber in a tube-like manner to the vessel.

5. The oil transformer according to claim 1, wherein the at least one second opening leads from the oil chamber to a cooling system outside the transformer vessel.

6. The oil transformer according to claim 1, wherein the oil chamber comprises:
a ring-shaped ground plate;
rib-like spacer elements arranged on the ground plate; and
low bordering walls at a radial outer and inner edge of the ground plate,
wherein the ground plate is manufactured together with at least one of the other elements as a monolithic part.

7. The oil transformer according to claim 6, wherein the rib-like spacer elements are shaped angular at their side-walls in a way which differs from a plane perpendicular to the ground plate, so that an axial creeping distance along the side walls is prolonged.

8. The oil transformer according to claim 6, wherein the monolithic part consists of laminated material.

9. The oil transformer according to claim 8, wherein the monolithic part consists of laminated material.

10. The oil transformer according to claim 2, wherein the at least one axial cooling channel of the transformer coil and the at least one first opening are arranged congruent to each other with respect to their respective cross sections.

11. The oil transformer according to claim 10, wherein the at least one second opening is prolonged from the oil chamber in a tube-like manner to the vessel.

12. The oil transformer according to claim 11, wherein the at least one second opening leads from the oil chamber to a cooling system outside the transformer vessel.

13. The oil transformer according to claim 2, wherein the oil chamber comprises:
a ring-shaped ground plate;
rib-like spacer elements arranged on the ground plate; and
low bordering walls at a radial outer and inner edge of the ground plate,
wherein the ground plate is manufactured together with at least one of the other elements as a monolithic part.

14. The oil transformer according to claim 13, wherein the rib-like spacer elements are shaped angular at their side-walls in a way which differs from a plane perpendicular to the ground plate, so that an axial creeping distance along the side walls is prolonged.

15. The oil transformer according to claim 14, wherein the monolithic part consists of laminated material.
